(19) United States
(12) Patent Application Publication
(10) Pub. No.: US 2006/0007473 A1
(43) Pub. Date: Jan. 12, 2006

(54) Videophone having integrated facsimile machine

(76) Inventor: Erin Zhu, Menlo Park, CA (US)

Correspondence Address: FORTUNE LAW GROUP LLP, 100 CENTURY CENTER COURT, SUITE 315, SAN JOSE, CA, 95112, US

(21) Appl. No.: 10/886,444

(22) Filed: Jul. 7, 2004

(51) Int. Cl. G06F 15/00

(52) U.S. Cl. 358/1.15

(57) ABSTRACT

An IP-based videophone having an integrated facsimile machine includes a network interface for connecting to an IP network, a processing circuit coupled to the network interface, the processing circuit including an image capturing and processing means for creating a video voicemail, an input interface coupled to the processing circuit, a video camera coupled to the input interface, an output interface coupled to the processing circuit, and a display device coupled to the output interface.

### BACKGROUND OF THE INVENTION

The present invention generally relates to communication devices and more particularly to an IP-based videophone having an integrated facsimile machine.

Videophones as well as facsimile machines are well known in the art. In addition, various devices are known which combine functions of conventional telephones with facsimile functions. For example, U.S. Pat. No. 5,631,745 entitled “Multi-Function Telecommunications Instrument” discloses a telephone terminal adapted for business or home use that includes the ability to receive and send facsimiles. Various input and output devices may be used for the facsimile function. A voice annotated facsimile may be sent and received. At the same time that facsimile is viewed on a video monitor or ordinary television set, an accompanying voice message may be heard through the sound system of the monitor or television set. The disclosed terminal does not include videophone functionality.

U.S. Pat. No. 5,910,815 entitled “Telephone Set” discloses a telephone having a base which can be connected to a telephone line, and a handset which includes speech circuits which are connected to the telephone line via the base. The telephone set further comprises a casing which includes a picture sensor producing a picture signal, and a screen forming a viewfinder. The user of the casing is analogous to the use of a photo camera. The picture is digitized, then stored and transmitted to the base to be transmitted by facsimile. The disclosed telephone set does not include videophone functionality.

A telephone system is disclosed in U.S. Pat. No. 6,192,118 entitled “Computer Telephone System and Method Having a Graphical User Interface”. The system provides telephone functions accessed through a client computer system. A server computer system provides telephone services, database services and access to e-mail, voice mail, video conferencing and facsimile systems. A graphical user interface is presented to a user to allow the user to perform a large number of functions and to access databases of information associated with calling and called parties. The disclosed system does not include an IP-based videophone having an integrated facsimile machine.

U.S. Pat. No. 6,380,967 entitled “System to Capture, Store, and Retrieve Composite Video for Transmission Over Telephone Lines” discloses a videophone system for transmitting and receiving still video images over a standard telephone line in response to a user command. A video processor circuit, comprising an A/D converter, a digital memory, a digital timing circuit, and a D/A converter, can grab a video image from a standard video camera and store one-half the number of lines of a video frame in the digital memory. A still video image can be displayed in a standard TV monitor by repeatedly sending the data stored in the digital memory to the D/A converter. The data stored in the digital memory can be transmitted using a standard modem to the digital memory of an equivalent system at a remote location, and the same still video image can be displayed at the remote location within a short time. Voice communication on the telephone line is temporarily suspended while data is transmitted, and automatically resumed when transmission is complete. The disclosed system transmits only still video images.

A videophone is disclosed in U.S. Pat. No. 6,510,325 entitled “Convertible Portable Telephone”. A display unit allows a user to display graphic information such as facsimile data or other graphic information such as that obtained from computer networks. An integrated camera allows the device to be used for video phone telephone calls. The disclosed device does not include a facsimile machine.

U.S. Pat. No. 6,570,676 entitled “Method and System the Transmission of Facsimile-Encoded Information Between Multimedia-Capable Communication Terminal Equipment” discloses a facsimile device including an image scanner means, a printer means, a modem, a communication controller, a multimedia multiplexer/demultiplexer, a facsimile encoder/decoder means, an audio input/output means, and a video input/output means. A network interface is provided for connecting the device to a communication network PSTN via the modem as well as by a telephone. The audio input/output means and video input/output means are external to the telephone. The disclosed system does not include an IP-based videophone having an integrated facsimile machine

An Image Transceiving Telephone with Integrated Digital Camera is disclosed in U.S. Pat. No. 6,724,416. The disclosed telephone is operable to simultaneously transceive real-time audio and non-real time images through the PSTN. The telephone includes an integrated telephone front end, a PSTN access device, an audio codec, an image input device, an image codec, an image display device, a local storage for an embedded system control software and associated control and operating parameters and data, an optional local electronic interface, a user-control and a system control including the embedded system control software. The disclosed telephone does not include an IP-based videophone having an integrated facsimile machine.

As can be seen, known videophones and facsimile machines do not incorporate the videophone and facsimile machine functionality in a single IP-based device. There is therefore a need in the art for an IP-based videophone having an integrated facsimile machine.

### SUMMARY OF THE INVENTION

In accordance with one aspect of the invention, an IP-based videophone having an integrated facsimile machine includes a network interface for connecting to an IP network, a processing circuit coupled to the network interface, the processing circuit including an image capturing and processing means for creating a video voicemail, an input interface coupled to the processing circuit, a video camera coupled to the input interface, an output interface coupled to the processing circuit, and a display device coupled to the output interface

In another aspect of the invention, an IP-based videophone having an integrated facsimile machine includes a housing, a processing circuit disposed within the housing, the processing circuit including an image capturing and processing means for creating a video voicemail, a network interface for connecting to an IP network coupled to the processing circuit, an input interface coupled to the processing circuit, a video camera coupled to the input interface, an output interface coupled to the processing circuit, and a display device coupled to the output interface.

In yet another aspect of the invention, an IP-based videophone having an integrated facsimile machine includes a housing, a processing circuit disposed within the housing, the processing circuit including an image capturing and processing means for creating a video voicemail, the video voicemail including data, video, and audio, a network interface for connecting to an IP network coupled to the processing circuit, an input interface coupled to the processing circuit, a video camera coupled to the input interface, a numeric keypad coupled to the input interface, a navigation device coupled to the input interface, an output interface coupled to the processing circuit, a display device coupled to the output interface, and a printer coupled to the output interface.

These and other features, aspects and advantages of the present invention will become better understood with reference to the following drawings, description and claims.

### BRIEF DESCRIPTION OF THE DRAWINGS

FIG. 1 is a schematic representation of an IP-based videophone having an integrated facsimile machine in accordance with the present invention; and

FIG. 2 is a schematic representation of a device circuit in accordance with the present invention.

### DETAILED DESCRIPTION OF THE INVENTION

The following detailed description is of the best modes of carrying out the invention. The description is not to be taken in a limiting sense, but is made merely for the purpose of illustrating the general principles of the invention, since the scope of the invention is best defined by the appended claims.

The present invention generally provides an IP-based videophone having an integrated facsimile machine. The functionalities of both a videophone and a facsimile machine are incorporated in a single standalone device coupleable to an IP network.

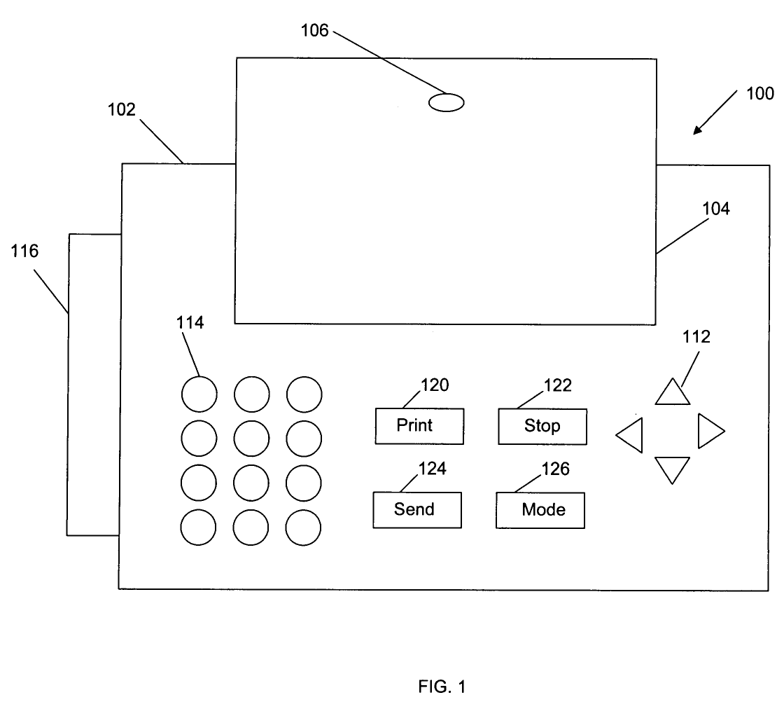

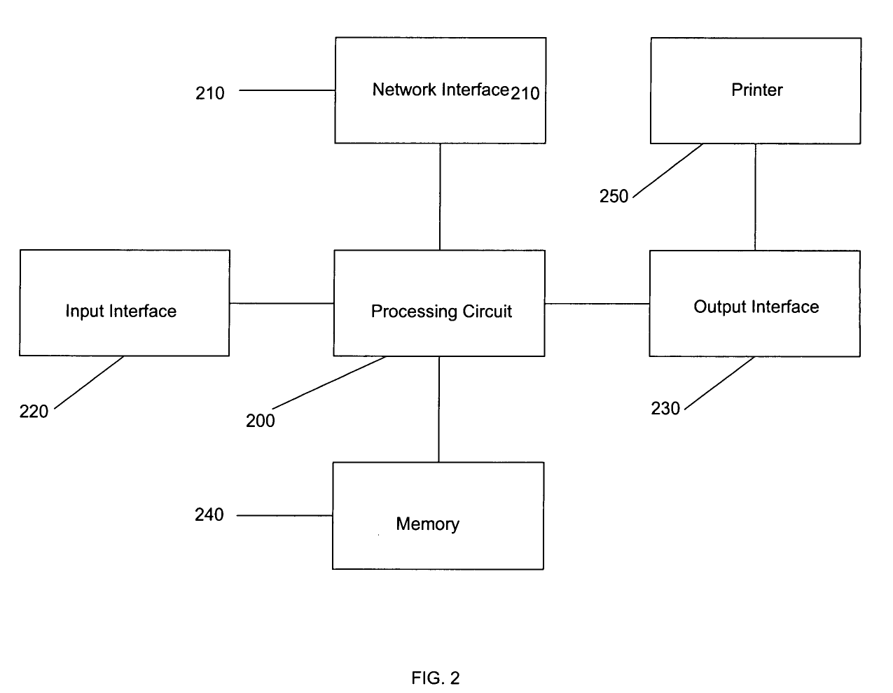

With reference to the FIG. 1 and FIG. 2, the IP videophone having an integrated facsimile machine generally designated 100 may include a housing 102. Housing 102 is shown as having a rectangular configuration but may have other configurations such as circular and oblong. Housing 102 is preferably sized and configured to fit on a user's desktop. A processing circuit 200 may be disposed within the housing 102 to provide videophone and facsimile functionality to the IP-based videophone device 100. The IP-based videophone device 100 may be powered by a power line (not shown).

IP-based videophone device 100 may include a display device 104 operable to display still and video images, and menus. A camera 106 may be disposed on display device 104 for capturing images for transmission as further described herein. Display device 104 may be coupled to an output interface 230. Camera 106 may be coupled to an input interface 220. Input interface 220 and output interface 220 may be coupled to processing circuit 200.

A handset 116 may be attachable to housing 102 in a conventional manner. Handset 116 may be coupled to input interface 220 to provide an audio input signal to processing circuit 200 and to output interface 230 to receive audio signals from processing circuit 200. Handset 116 preferably operates as a conventional telephone handset.

Housing 102 may include a keypad 114 coupled to input interface 220. Keypad 114 may include a numeric keypad. A navigation means 112 coupled to input interface 220 may include a plurality of buttons for navigating images and menus displayed in display device 104.

A network interface 210 may be coupled to processing circuit 200. Network interface 210 preferably includes an Ethernet interface. Network interface 210 may provide IP connectivity to the IP-based videophone device 100. Network interface 210 may include a USB interface for connecting IP-based videophone device 100 to an external printer or personal computer.

Output interface 230 may be coupled to processing circuit 200. Output interface 230 may be operable to provide still and video images to display device 104. A memory device 240 may be coupled to processing circuit 200 for storing program instructions, audio/video recordings and video/voice mail, and images.

IP-based videophone device 100 may be operable to send and receive documents by facsimile transmission. A paper document may be insertable in IP-based videophone device 100 for transmission and display on display device 104. A printer 250 may be coupled to output interface 230 for printing of a received facsimile transmission by selecting a print button 120. Alternatively, the received facsimile transmission may be displayed on display device 104 and sent to the external printer coupled to IP-based videophone device 100.

A mode selection button 126 coupled to input interface 220 may be operable to select either a store-and-forward mode or a real-time mode. In the store-and-forward mode, a sender may make an IP connection to a recipient's IP-based videophone device 100, load documents to be sent, create an audio/video file, and send a video/voice mail to the recipient's machine by pressing a send button 124. The video/voice mail may include data, audio, and video. The recipient may then view the video/voice mail at any time, review any transmitted documents on display device 104, print the transmitted documents, and view the audio/video file on display device 104.

In real-time mode, a call receiver may be present at a remote IP-based videophone device 100 to receive an incoming call. A call initiator and the call receiver may talk using handsets 116 and view each other's images and view each other's documents on respective display devices 104. Navigation means 112 may be operable to provide page back/forward and zoom functionality. In real-time mode, documents transmitted as well as audio/video transmitted may be saved for future viewing in memory device 240.

The IP-based videophone having integrated facsimile machine of the present invention solves the problems of prior art by incorporating the functionalities of both a videophone and a facsimile machine in a single standalone device coupleable to an IP network.

It should be understood, of course, that the foregoing relates to preferred embodiments of the invention and that modifications may be made without departing from the spirit and scope of the invention as set forth in the following claims.

We claim:

1. An IP-based videophone having an integrated facsimile machine comprising:
a network interface for connecting to an IP network;
a processing circuit coupled to the network interface, the processing circuit including an image capturing and processing means for creating a video voicemail;
an input interface coupled to the processing circuit;
a video camera coupled to the input interface;
an output interface coupled to the processing circuit; and
a display device coupled to the output interface.

2. The IP-based videophone having an integrated facsimile machine of claim 1, wherein the network interface comprises an Ethernet interface.

3. The IP-based videophone having an integrated facsimile machine of claim 1, wherein the network interface comprises a USB interface.

4. The IP-based videophone having an integrated facsimile machine of claim 1, wherein the video voicemail comprises data, video, and audio.

5. The IP-based videophone having an integrated facsimile machine of claim 1, further comprising a numeric keypad coupled to the input interface.

6. The IP-based videophone having an integrated facsimile machine of claim 1, further comprising a navigation device coupled to the input interface.

7. The IP-based videophone having an integrated facsimile machine of claim 1, further comprising a mode button coupled to the input interface, the mode button operable to select between and store-and-forward mode of operation and a real-time mode of operation.

8. The IP-based videophone having an integrated facsimile machine of claim 1, further comprising a printer coupled to the output interface.

9. An IP-based videophone having an integrated facsimile machine comprising:
a housing;
a processing circuit disposed within the housing, the processing circuit including an image capturing and processing means for creating a video voicemail;
a network interface for connecting to an IP network coupled to the processing circuit;
an input interface coupled to the processing circuit;
a video camera coupled to the input interface;
an output interface coupled to the processing circuit; and
a display device coupled to the output interface.

10. The IP-based videophone having an integrated facsimile machine of claim 9, wherein the network interface comprises an Ethernet interface.

11. The IP-based videophone having an integrated facsimile machine of claim 9, wherein the network interface comprises a USB interface.

12. The IP-based videophone having an integrated facsimile machine of claim 9, wherein the video voicemail comprises data, video, and audio.

13. The IP-based videophone having an integrated facsimile machine of claim 9, further comprising a numeric keypad coupled to the input interface.

14. The IP-based videophone having an integrated facsimile machine of claim 9, further comprising a navigation device coupled to the input interface.

15. The IP-based videophone having an integrated facsimile machine of claim 9, further comprising a mode button coupled to the input interface, the mode button operable to select between and store-and-forward mode of operation and a real-time mode of operation.

16. The IP-based videophone having an integrated facsimile machine of claim 9, further comprising a printer coupled to the output interface.

17. An IP-based videophone having an integrated facsimile machine comprising:
a housing;
a processing circuit disposed within the housing, the processing circuit including an image capturing and processing means for creating a video voicemail, the video voicemail including data, video, and audio;
a network interface for connecting to an IP network coupled to the processing circuit;
an input interface coupled to the processing circuit;
a video camera coupled to the input interface;
a numeric keypad coupled to the input interface;
a navigation device coupled to the input interface;
an output interface coupled to the processing circuit;
a display device coupled to the output interface; and
a printer coupled to the output interface.

18. The IP-based videophone having an integrated facsimile machine of claim 17, wherein the network interface comprises an Ethernet interface.

19. The IP-based videophone having an integrated facsimile machine of claim 17, wherein the network interface comprises a USB interface.

20. The IP-based videophone having an integrated facsimile machine of claim 17, further comprising a mode button coupled to the input interface, the mode button operable to select between and store-and-forward mode of operation and a real-time mode of operation.
